(19) United States
(12) Patent Application Publication
(10) Pub. No.: US 2021/0241755 A1
(43) Pub. Date: Aug. 5, 2021

(54) INFORMATION-PROCESSING DEVICE AND INFORMATION-PROCESSING METHOD

(71) Applicant: NTT DOCOMO, INC., Tokyo (JP)

(72) Inventors: Kousuke KADONO, Tokyo (JP); Yuuki SAITOU, Tokyo (JP); Youhei OONO, Tokyo (JP); Yuichiro SEGAWA, Toyko (JP)

(73) Assignee: NTT DOCOMO, INC., Tokyo (JP)

(21) Appl. No.: 16/647,682

(22) PCT Filed: Nov. 20, 2018
(86) PCT No.: PCT/JP2018/042884

§ 371 Date: Mar. 16, 2020

(30) Foreign Application Priority Data
Nov. 24, 2017 (JP) 2017-225814

(51) Int. Cl. G10L 15/18; G06N 20/00; G10L 15/22; G10L 15/06; G10L 15/19; G10L 15/30

(52) U.S. Cl. CPC G10L 15/1815; G06N 20/00; G10L 15/30; G10L 15/063; G10L 15/19; G10L 15/22

(57) ABSTRACT

An information-processing device includes an acquisition unit that acquires input data corresponding to spoken words input to a user terminal, and acquires response data output from a dialog processing device that perform processing according to the input data. A learning unit learns an input rule for data input to the dialog processing device based on the input data and the response data. A conversion unit converts the input data into another input data so that the input data meets the input rule that has been learned by the learning unit for the dialog processing device to which the input data is input. An output unit provides the other input data generated by the conversion unit to the dialog processing device.

### TECHNICAL FIELD

The present invention relates to a technique for performing processing according to voice.

### BACKGROUND

With recent improvements in speech recognition technology, services that enable users to vocally initiate different types of processing have become widely available. For example, Publication No. WO 2008/150003 A1 discloses a system in which a front-end device receives a keyword input by keyboard or mouse while inputting voice data to an associated system, and identifies a keyword present in the voice data.

### SUMMARY OF INVENTION

In the system disclosed in Publication No. WO 2008/150003 A1 a user is required to input a keyword in addition to speaking, which is time consuming and inefficient. To overcome this problem, the present invention is thus directed to converting words spoken by a user into a format that can be understood by a dialog processing device, without recourse to input other than speaking.

To solve the problem, the present invention provides an information-processing device comprising: an acquisition unit configured to acquire input data corresponding to spoken words input to a user terminal, and response data output from one or more dialog processing devices that perform processing according to the input data; a learning unit configured to learn an input rule for data input to the one or more dialog processing devices, on the basis of the input data and the response data; a conversion unit configured to convert the input data into another input data so that the input data meets an input rule that has been learned by the learning unit for the one or more dialog processing devices to which the input data is input; and an output unit configured to output the other input data generated by the conversion unit to the one or more dialog processing devices.

The conversion unit, upon detecting that the input data does not meet the input rule, may be configured to convert the input data into the other input data that meets the input rule.

The conversion unit may be configured to convert data corresponding to a pronoun included in the input data into data corresponding to a noun indicated by the pronoun.

The conversion unit may be configured to convert the input data into the other input data in which words are separated in accordance with the input rule.

The conversion unit, upon detecting that the input data has an abstraction level that does not meet the input rule, may be configured to convert the input data into the other input data having an abstraction level that meets the input rule.

The conversion unit, upon detecting that the input data does not meet the input rule, may be configured to convert the input data into text data that meets the input rule, and to convert text data that is output from the one or more dialog processing devices in response to the text data, into input data, and the output unit may be further configured to output the input data generated by the conversion unit to the user terminal.

The learning unit may be further configured to learn, on the basis of the input data and the response data, one of the one or more dialog processing devices to which the input data is input, and the output unit may be configured to output the other input data generated by the conversion unit to one of the one or more dialog processing devices that is identified based on results of learning of the learning unit.

The output unit may be configured to select one of the one or more dialog processing devices that have been identified based on results of learning of the learning unit, based on a condition on a distance between the user terminal and a provider that provides a product to a user of the user terminal or on a delivery time, and to output the other input data generated by the conversion unit to the selected one of the one or more dialog processing devices.

The learning unit may be configured to perform learning on a basis of input by a user of the user terminal or a group to which the user belongs, and the output unit may be configured to output information corresponding to a user of the user terminal or a group to which the user belongs, to the user terminal.

The present invention also provides an information-processing method comprising: acquiring input data corresponding to spoken words input to a user terminal, and response data output from one or more dialog processing devices that perform processing according to the input data; learning an input rule for data to be input to the one or more dialog processing devices, on the basis of the input data and the response data; converting the input data into another input data so that the input data meets an input rule that has been learned for the one or more dialog processing devices to which the input data is to be input; and outputting the other input data to the one or more dialog processing devices.

The present invention enables words spoken by a user to be converted into a format that can be understood by a dialog processing device, without recourse to input other than speaking.

### BRIEF DESCRIPTION OF DRAWINGS

FIG. 1 is a diagram showing a configuration of a dialog processing system according to an embodiment of the present invention, in accordance to the present invention.

FIG. 2 is a diagram showing a hardware configuration of a relay device according to the embodiment, in accordance to the present invention.

FIG. 3 is a diagram showing a functional configuration of the relay device, in accordance to the present invention.

FIG. 4 is a flowchart showing processing carried out by the relay device, in accordance to the present invention.

FIG. 5 is a flowchart showing processing carried out by the relay device, in accordance to the present invention.

FIG. 6a is a diagram showing an example of learning carried out by the relay device, in accordance to the present invention.

FIG. 6b is a diagram showing an example of learning carried out by the relay device, in accordance to the present invention.

FIG. 6c is a diagram showing an example of learning carried out by the relay device, in accordance to the present invention.

FIG. 6d is a diagram showing an example of learning carried out by the relay device, in accordance to the present invention.

### REFERENCE SIGN LIST

1 relay device
101 control unit
102 communication unit
103 storage unit
11 acquisition unit
12 learning unit
13 conversion unit
14 output unit
2 user terminal
3a, 3b dialog processing device
4 communication network

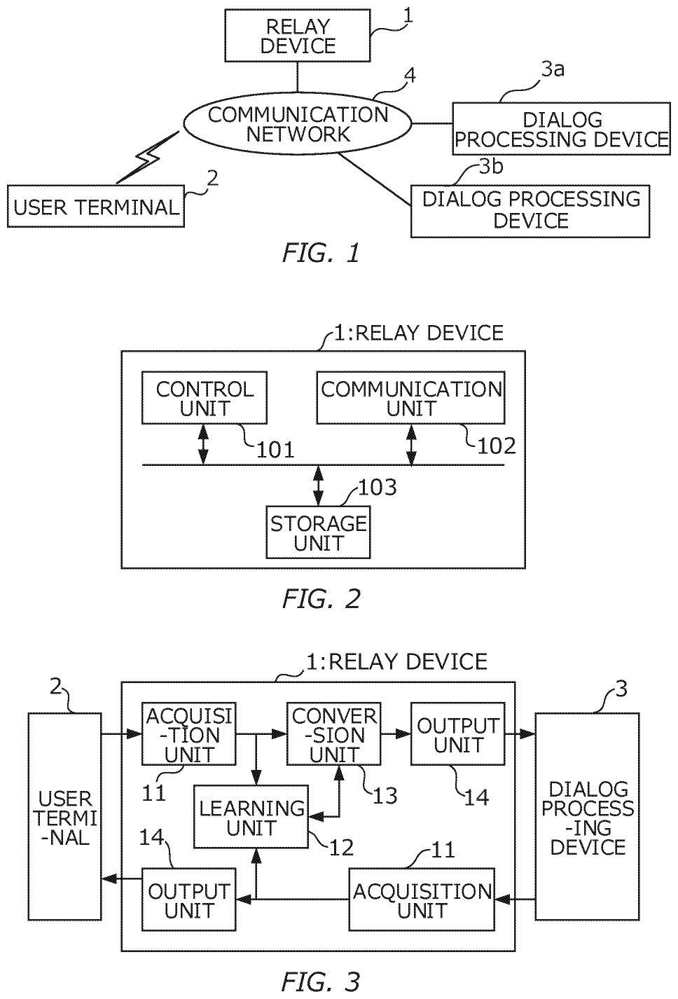

FIG. 1 is a block diagram showing a configuration of a dialog processing system according to an embodiment of the present invention. The dialog processing system includes: relay device 1, which is an example of an information-processing device according to the present invention; user terminal 2, for use by a speech user; dialog processing devices 3a and 3b, each of which is able to recognize words spoken by the user, and perform processing according to the recognized words (hereafter, referred to as “dialog processing function”); and communication network 4, which enables relay device 1, user terminal 2, and dialog processing device 3a and 3b to communicate with each other. User terminal 2 may be a portable computer such as a smartphone or a tablet, or a stationary computer provided at a user's home. Communication network 4 may be a mobile communication network or a fixed communication network. User terminal 2 may connect wirelessly to the mobile communication network. In FIG. 1, two dialog processing devices 3a and 3b are shown; however, a number of dialog processing devices is not limited to two, and may be one or more. The number of user terminals 2 also is not limited to one. In the following description, dialog processing devices 3a and 3b are referred to collectively as dialog processing device 3.

Dialog processing devices 3a and 3b are each computers operated and managed by different operators. For example, dialog processing device 3a may be a device that enables a user to order a pizza delivery by voice; and dialog processing device 3b may be a device that enables a user to order daily necessities and other goods by voice. Each of dialog processing devices 3a and 3b has determined rules that should be followed by the user who inputs a voice instruction. The determined rules are hereafter referred to as input rules. For example, dialog processing device 3a enables delivery of pizzas having specified names, and dialog processing device 3b enable order of daily necessities having specified product names. Correctly pronouncing a pizza name or product name for input to dialog processing device 3a or 3b corresponds to the input rule.

Relay device 1 is a computer that relays data between user terminal 2 and dialog processing device 3a or 3b. Relay device 1 functions as a platform. Relay device 1 receives data input via user terminal 2 and data output via dialog processing device 3a or 3b to learn an input rule that the user's words to be input to dialog processing device 3a or 3b should follow. Relay device 1 converts the user's words into a format understandable to dialog processing device 3a or 3b in accordance with the learned input rule.

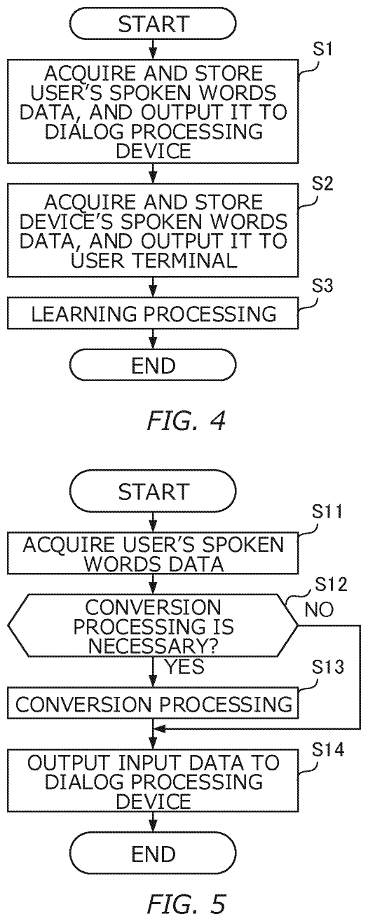

FIG. 2 is a block diagram showing a hardware configuration of relay device 1, which includes control unit 101, communication unit 102, and storage unit 103. Control unit 101 includes a processor such as a central processing unit (CPU) and a storage device such as a read only memory (ROM) and a random access memory (RAM). The CPU executes a program stored in the ROM or storage unit 103 while using the RAM as a work area, to control components of relay device 1.

Communication unit 102 is hardware (a transmitting and receiving device) for enabling communication between computers via wired and/or wireless network(s).

Communication unit 102 may be referred to as a network device, a network controller, a network card, or a communication module. Communication unit 102 connects to communication network 4.

Storage unit 103 is a computer-readable recording medium, and, for example, includes at least one of an optical disk such as a compact disc ROM (CD-ROM), a hard disk drive, a flexible disk, and a magneto-optical disk (for example, a compact disk, a digital versatile disk, a Blu-ray (registered trademark) disk), a smart card, a flash memory (for example, a card, a stick, a key drive), a floppy (registered trademark) disk, and a magnetic strip. Storage unit 103 may be referred to as an auxiliary storage device. Storage unit 103 stores data and programs for use by control unit 101.

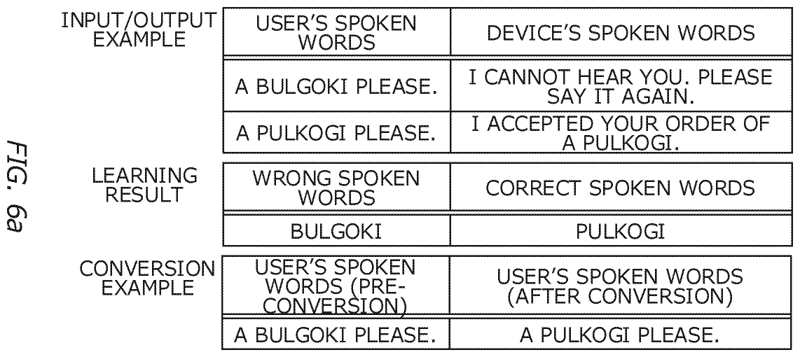

FIG. 3 is a block diagram showing a functional configuration of relay device 1, which includes acquisition unit 11 and output unit 14, which are mainly realized by communication unit 102, and learning unit 12 and conversion unit 13, which are mainly realized by control unit 101 and storage unit 103.

User terminal 2 includes a microphone that picks up the user's voice and generates corresponding input data. User terminal 2 sends the generated input data to relay device 1 via communication network 4. The input data may refer to text data into which voice data representing the user's voice has been converted by user terminal 2. Alternatively, the input data may refer to voice data that represents the user's voice, or data generated by performing processing on the voice data in user terminal 2. Acquisition unit 11 of relay device 1 acquires the input data input to user terminal 2, via communication network 4, and acquires response data sent from dialog processing device 3 in response to the input data, via communication network 4. The response data may refer to text data or voice data as in the case of the input data.

Learning unit 12 learns an input rule for data to be input to dialog processing device 3 on the basis of input data and response data acquired by acquisition unit 11. Specifically, learning unit 12 learns an input rule on the basis of a correspondence between input data and response data. Input rules are different for each dialog processing device 3a and 3b; accordingly, learning unit 12 learns input rules for each dialog processing device 3a and 3b.

Conversion unit 13 converts input data acquired by acquisition unit 11 so that the input data meets an input rule that has been learned by learning unit 12 for dialog processing device 3 to which the input data is to be input. Specifically, conversion unit 13, upon detecting that the acquired input data does not meet an input rule, converts the input data into input data that meets the input rule, thereby correcting an error in spoken words. Alternatively, conversion unit 13 converts data corresponding to a pronoun included in the acquired input data into data corresponding to a noun indicated by the pronoun, thereby converting a spoken pronoun into a specific name. Alternatively, conversion unit 13 converts the acquired input data into input data in which words are separated in accordance with an input rule, thereby separating a set of words included in a set of spoken words into sets of words. Alternatively, conversion unit 13, upon detecting that the acquired input data has an abstraction level that does not meet an input rule, converts the input data into input data having an abstraction level that meets the input rule, thereby converting the abstraction level of spoken words into one that is appropriate.

Output unit 14 outputs data converted by conversion unit 13 to dialog processing device 3 via communication network 4. Also, output unit 14 outputs response data sent from the dialog processing device 3 to user terminal 2 via communication network 4.

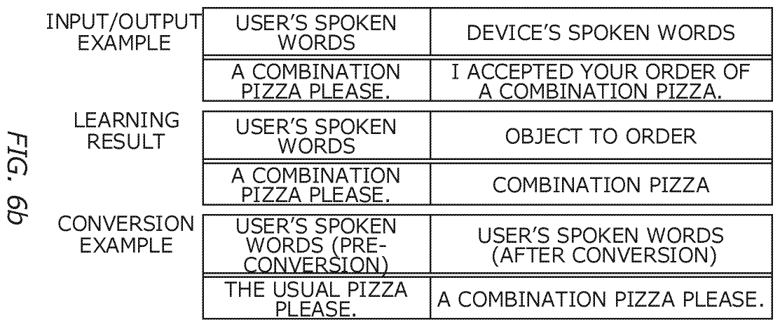

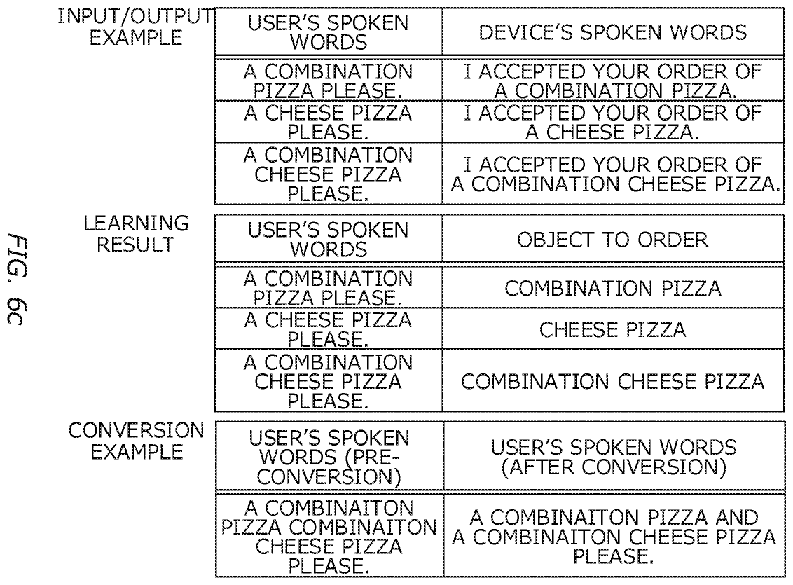

An operation of the present embodiment will now be described with reference to FIGS. 4 to 6. In the processing described in the following, user terminal 2 and dialog processing device 3 send data together with its identification information.

First, a learning operation of relay device 1 is described. The user of user terminal 2 utters a predetermined keyword to activate the dialog processing function. When picking up the uttered keyword, user terminal 2 activates the dialog processing function. Subsequently, the user designates one of dialog processing devices 3 and utters words indicative of desired processing. Acquisition unit 11 of relay device 1 acquires input data corresponding to the words input to user terminal 2, via communication network 4, and stores the input data. Output unit 14 outputs the input data to the designated dialog processing device 3 via communication network 4 (step S1). The dialog processing device 3 sends response data to relay device 1 in response to the input data. Acquisition unit 11 acquires the response data via communication network 4 and stores the response data. Output unit 14 outputs the response data to user terminal 2 via communication network 4 (step S2). Learning unit 12 learns an input rule for data input to the dialog processing device 3 based on the stored input data and response data (step S3).

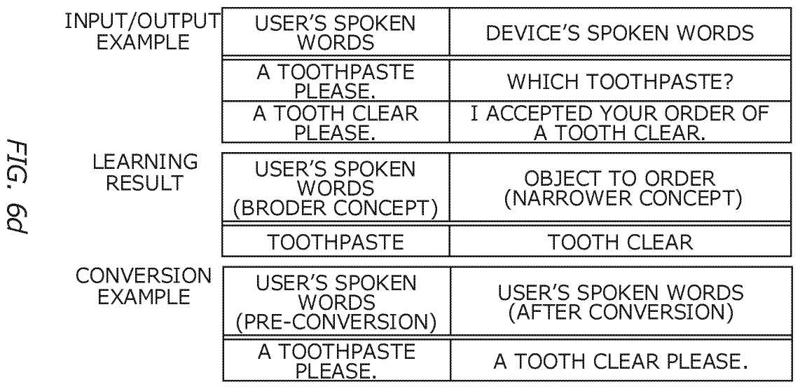

Below, examples of learning are described. As shown in FIG. 6a, it is assumed that words uttered by the user (hereafter referred to as a user's spoken words) are “A bulgoki please.,” and response data sent from the dialog processing device 3 (hereafter referred to as a device's spoken words) is for a response “I cannot hear you. Please say it again.” It is also assumed that subsequent user's spoken words are “A pulkogi please.,” and the corresponding device's spoken words are “I accepted your order of a pulkogi.” Learning unit 12 subjects this conversation to natural language analysis including morphological analysis, syntax analysis, semantic analysis, and context analysis, thereby determining that the word “bulgoki” has been converted into “pulkogi.” As a result, learning unit 12 learns that the incorrect word “bulgoki” uttered by the user should be converted into the correct word “pulkogi” before being input to the dialog processing device 3. In other words, learning unit 12 learns that a word that can be accepted by the dialog processing device 3 is “pulkogi.” An exemplary conversion of a user's spoken words includes converting “A bulgoki please.” into “A pulkogi please.”

As shown in FIG. 6b, it is assumed that the user's spoken words are “A combination pizza please.,” and the device's spoken words are “I accepted your order of a combination pizza.” It is also assumed that such a conversation has taken place several times. Learning unit 12 subjects the conversation to natural language analysis, thereby learning that the object “combination pizza” included in the user's spoken words “A combination pizza please” is an order object that can be accepted by dialog processing device 3, and that the object has been repeatedly ordered by the user. An exemplary conversion of the user's spoken words includes converting “The usual pizza please.” into “A combination pizza please.,” whereby input data that does not meet an input rule is converted into input data that meets the input rule.

As shown in FIG. 6c, it is assumed that the user's spoken words are “A combination pizza please.,” and the device's spoken words are “I accepted your order of a combination pizza.” It is also assumed that the user's spoken words are “A cheese pizza please.,” and the device's spoken words are “I accepted your order of a cheese pizza.” It is also assumed that the user's spoken words are “A combination cheese pizza please.,” and the device's spoken words are “I accepted your order of a combination cheese pizza.” Learning unit 12 subjects the conversation to natural language analysis, thereby learning that the object “combination pizza” included in the user's spoken words “A combination pizza please” is an independent order object, that the object “cheese pizza” included in the user's spoken words “A cheese pizza please” is an independent order object, and that the object “combination cheese pizza” included in the user's spoken words “A combination cheese pizza please” is an independent order object. In short, learning unit 12 learns that dialog processing device 3 can accept each of the objects “combination pizza,” “cheese pizza,” and “combination cheese pizza” as an independent order object. An exemplary conversion of the user's spoken words includes converting “A combination pizza combination cheese pizza please,” in which order objects are connected, into “A combination pizza and a combination cheese pizza please,” in which order objects are separated. Thereby, data corresponding to a pronoun included in input data is converted into data corresponding to a noun indicated by the pronoun, and input data is converted into input data in which words are separated in accordance with an input rule.

As shown in FIG. 6d, it is assumed that the user's spoken words are “A toothpaste please.,” and the device's spoken words are “Which toothpaste?” It is also assumed that subsequent user's spoken words are “A Tooth Clear please.,” and the corresponding device's spoken words are “I accepted your order of a Tooth Clear.” Learning unit 12 subjects the conversation to natural language analysis, thereby learning that dialog processing device 3 is provided with input of a product name “Tooth Clear” (broader concept), not a category name “toothpaste” (narrower concept). An exemplary conversion of user's spoken words includes converting “A toothpaste please.” into “A Tooth Clear please,” whereby input data having an abstraction level that does not meet an input rule is converted into input data having an abstraction level that meets the input rule.

Each time acquisition unit 11 of relay device 1 acquires input data and response data, learning processing as illustrated in the foregoing is carried out. A learned input rule is stored in learning unit 12 in association with identification information of dialog processing device 3 and identification information of user terminal 2.

Now, a conversion operation of relay device 1 will be described. The user of user terminal 2 utters a predetermined keyword to activate the dialog processing function. When picking up the uttered keyword, user terminal 2 activates the dialog processing function. Subsequently, the user designates one of dialog processing devices 3 and utters words indicative of desired processing. Acquisition unit 11 of relay device 1 acquires input data corresponding to the words input to user terminal 2, via communication network 4, and stores the input data (step S11). Conversion unit 13 refers to learned input rules stored in learning unit 12 in association with identification information of the dialog processing device 3 and identification information of user terminal 2, to determine whether the input data needs to be converted (step S12). In a case where the input data meets the input rules, conversion unit 13 determines that the input data does not need to be converted, and in a case where the input data does not meet one of the input rules, conversion unit 13 determines that the input data needs to be converted.

If it is determined that the input data needs to be converted, conversion unit 13 performs conversion processing on the input data in accordance with the one of the input rules (step S13). Output unit 14 outputs the converted input data to the dialog processing device 3 via communication network 4 (step S14). Thereafter, each time acquisition unit 11 of relay device 1 acquires input data from user terminal 2 via communication network 4, conversion processing is carried out.

According to the embodiment described above, it possible to convert a user's input data into a format understandable to dialog processing device 3, without referring to input other than spoken words.

The above embodiment may be modified as described below. The modifications described below may be implemented in combination.

Learning unit 12 may learn to which dialog processing device 3 input data is input. Specifically, in an initial stage, the user designates one of dialog processing devices 3 and utters words indicative of desired processing, and learning unit 12 learns a correspondence between the user's input data and the designated dialog processing devices 3. For example, learning unit 12 learns, for each of user terminals 2, a correspondence between input data representing “A combination pizza please.,” “A cheese pizza please.,” or “A combination cheese pizza please,” which includes a word “pizza,” and dialog processing device 3a. Learning unit 12 learns, on the basis of acquired input data and response data, one of dialog processing devices 3 to which the acquired input data is input. The acquired input data is converted by conversion unit 13 into another input data. Output unit 14 outputs the other input data to one of dialog processing devices 3 that is identified based on a correspondence(s) learned by learning unit 12. As the user uses this system longer, learning of learning unit 12 advances, and ultimately, the user can get his/her spoken words across to his/her desired dialog processing device 3, without having to designate the dialog processing device 3.

In a case where the user requests a service in which dialog processing device 3 instructs a store to deliver the user's designated product to him/her, output unit 14 may determine which dialog processing device 3 the user's input data is to be input, based on a condition on a distance between the user and the store or on a delivery time. For example, output unit 14 may acquire a location of the user and locations of stores corresponding to dialog processing devices 3, and calculate a distance or delivery time for each pair of the user's location and a store's location. Subsequently, output unit 14 may identify a store for which a calculated distance or delivery time is shortest, and determine dialog processing device 3 corresponding to the identified store, as a destination of the user's input data. In another example, the user may be allowed to designate a delivery date and time. In this case, output unit 14 may acquire a location of the user and locations of stores corresponding to dialog processing devices 3, and calculate a delivery time for each pair of the user's location and one a store's location. Subsequently, output unit 14 may identify a store for which a calculated delivery time does not go beyond the user's designated delivery date and time, and determine a dialog processing device 3 corresponding to the identified store, as a destination of the user's input data. In summary, output unit 14 selects one of dialog processing devices 3 that have been identified based on results of learning of learning unit 12, based on a condition on a distance between user terminal 2 and a provider that provides a product to the user of user terminal 2 or on a delivery time. Subsequently, output unit 14 outputs data generated by conversion unit 13 to the selected dialog processing devices 3.

Learning unit 12 may perform learning based on data input by a single user or by users in a user group. The user group herein refers to an office organization or a family. To enable learning unit 12 to perform such learning, user terminal 2 sends data together with its identification information and identification information of a user group to which the user of user terminal 2 belongs, whereby learning unit 12 performs learning based on data input by a user of user terminal 2 or a group to which the user belongs. Output unit 14 outputs information corresponding to a user of user terminal 2 or a group to which the user belongs, to user terminal 2.

In the embodiment, learning unit 12 learns an input rule based on the user's input data and response data, and stores the input rule in association with identification information of dialog processing device 3 and identification information of user terminal 2. In this embodiment, input rules may be shared by users. For example, a first user may share an input rule with a second user, which input rule has been learned based on the first user's input data and response data. The input rules described with reference to FIGS. 6a and 6c are examples of input rules that are common to plural users. As shown in FIG. 6a, it is assumed that the first user's spoken words are “A bulgoki please.,” and corresponding device's spoken words are “I cannot hear you. Please say it again.” It is also assumed that the first user's subsequent spoken words are “A pulkogi please.,” and a corresponding device's spoken words are “I accepted your order of a pulkogi.” Learning unit 12 subjects this conversation to natural language analysis, thereby determining that the word “bulgoki” has been converted into “pulkogi.” As a result, learning unit 12 learns that the incorrect word “bulgoki” uttered by the first user should be converted into the correct word “pulkogi” before being input to the dialog processing device 3. In other words, learning unit 12 learns that a word that can be accepted by the dialog processing device 3 is “pulkogi.” After such an input rule is learned, conversion unit 13 may determine whether input data input by the second user, not the first user, meets the input rule. In a case where the input data meets the input rule, conversion unit 13 does not convert the input data, and in a case where the input data does not meet the input rule, conversion unit 13 converts the input data into other input data. For example, in a case where the second user's spoken words are “A bulgoki please.,” conversion unit 13 converts this into “A pulkogi please.” in accordance with the input rule. The same applies to the example shown in FIG. 6c.

The block diagrams used to describe the above embodiment show blocks of functional units. The blocks of functional units may be provided using any combination of items of hardware and/or software. Means for providing the blocks of functional units are not limited. The blocks of functional units may be provided using a single device including physically and/or logically combined components, or two or more physically and/or logically separated devices that are directly and/or indirectly connected by wire and/or wirelessly.

For example, relay device 1 may refer to a single device including all of the functions shown in FIG. 3, or to a system in which all of the functions are distributed to plural devices. In another example, relay device 1 may include at least a part of the functions of dialog processing device 3. In another example, relay device 1 may include a dedicated dialog function different from dialog processing device 3, which function enables a dialog with the user before the user starts a dialog sequence with dialog processing device 3.

The embodiments described in the present specification may be applied to a system using LTE, LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-Wide Band (UWB), Bluetooth (registered trademark), or another appropriate system, or to a next-generation system that is expanded based on those systems.

The order of the processes, sequence, or flowcharts in the embodiments described in the present specification may be changed as long as consistency is maintained. Methods described in the present specification include steps arranged in an exemplary order, but the steps may be arranged in another order.

The embodiments described in the present specification may be used separately or in combination, with minor changes. A notification of information (for example, a notification of “being X”) may be made explicitly or implicitly.

The terms “system” and “network” used in the present specification are used interchangeably.

The term “determining” used in the present specification may refer to various actions. For example, the term “determining” may refer to judging, calculating, computing, processing, deriving, investigating, looking up (for example, looking up information in a table, a database, or a data structure), and ascertaining. The term “determining” may also refer to receiving (for example, receiving information), transmitting (for example, transmitting information), inputting, outputting, and accessing (for example, accessing data in memory). The term “determining” may also refer to resolving, selecting, choosing, establishing, and comparing.

The present invention may be implemented in an information-processing method performed by relay device 1 (an information-processing device), or in a program for causing a computer to function as relay device 1 (an information-processing device). The program may be distributed in the form of a recording medium such as an optical disc, or may be downloaded and installed to a computer via a network such as the Internet.

The present invention is described in detail in the foregoing; however, it is apparent to those skilled in the art that the present invention is not limited to the embodiments described in the present specification. The present invention may be implemented in modified or changed embodiments, without departing from the spirit and scope of the present invention defined by the description of the claims. The description in the present specification is for illustrative purposes and is not intended to limit the present invention in any way.

What is claimed is:

1-10. (canceled)

11. An information-processing device comprising:
an acquisition unit configured to acquire input data corresponding to spoken words input to a user terminal, and response data output from one or more dialog processing devices that perform processing according to the input data;
a learning unit configured to learn an input rule for data input to the one or more dialog processing devices, on the basis of the input data and the response data;
a conversion unit configured to convert the input data into another input data so that the input data meets an input rule that has been learned by the learning unit for the one or more dialog processing devices to which the input data is input; and
an output unit configured to output the other input data generated by the conversion unit to the one or more dialog processing devices.

12. The information-processing device according to claim 11, wherein the conversion unit, upon detecting that the input data does not meet the input rule, is configured to convert the input data into the other input data that meets the input rule.

13. The information-processing device according to claim 11, wherein the conversion unit is configured to convert data corresponding to a pronoun included in the input data into data corresponding to a noun indicated by the pronoun.

14. The information-processing device according to claim 11, wherein the conversion unit is configured to convert the input data into the other input data in which words are separated in accordance with the input rule.

15. The information-processing device according to claim 11, wherein the conversion unit, upon detecting that the input data has an abstraction level that does not meet the input rule, is configured to convert the input data into the other input data having an abstraction level that meets the input rule.

16. The information-processing device according to claim 11, wherein:
the conversion unit, upon detecting that the input data does not meet the input rule, is configured to convert the input data into text data that meets the input rule, and to convert text data that is output from the one or more dialog processing devices in response to the text data, into input data; and
the output unit is further configured to output the input data generated by the conversion unit to the user terminal.

17. The information-processing device according claim 12, wherein:
the conversion unit, upon detecting that the input data does not meet the input rule, is configured to convert the input data into text data that meets the input rule, and to convert text data that is output from the one or more dialog processing devices in response to the text data, into input data; and
the output unit is further configured to output the input data generated by the conversion unit to the user terminal.

18. The information-processing device according to claim 13, wherein:
the conversion unit, upon detecting that the input data does not meet the input rule, is configured to convert the input data into text data that meets the input rule, and to convert text data that is output from the one or more dialog processing devices in response to the text data, into input data; and
the output unit is further configured to output the input data generated by the conversion unit to the user terminal.

19. The information-processing device according to claim 14, wherein:
the conversion unit, upon detecting that the input data does not meet the input rule, is configured to convert the input data into text data that meets the input rule, and to convert text data that is output from the one or more dialog processing devices in response to the text data, into input data; and
the output unit is further configured to output the input data generated by the conversion unit to the user terminal.

20. The information-processing device according to claim 15, wherein:
the conversion unit, upon detecting that the input data does not meet the input rule, is configured to convert the input data into text data that meets the input rule, and to convert text data that is output from the one or more dialog processing devices in response to the text data, into input data; and
the output unit is further configured to output the input data generated by the conversion unit to the user terminal.

21. The information-processing device according to claim 11, wherein:
the learning unit is further configured to learn, on the basis of the input data and the response data, one of the one or more dialog processing devices to which the input data is input; and
the output unit is configured to output the other input data generated by the conversion unit to one of the one or more dialog processing devices that is identified based on results of learning of the learning unit.

22. The information-processing device according to claim 12, wherein:
the learning unit is further configured to learn, on the basis of the input data and the response data, one of the one or more dialog processing devices to which the input data is input; and
the output unit is configured to output the other input data generated by the conversion unit to one of the one or more dialog processing devices that is identified based on results of learning of the learning unit.

23. The information-processing device according to claim 13, wherein:
the learning unit is further configured to learn, on the basis of the input data and the response data, one of the one or more dialog processing devices to which the input data is input; and
the output unit is configured to output the other input data generated by the conversion unit to one of the one or more dialog processing devices that is identified based on results of learning of the learning unit.

24. The information-processing device according to claim 14, wherein:
the learning unit is further configured to learn, on the basis of the input data and the response data, one of the one or more dialog processing devices to which the input data is input; and
the output unit is configured to output the other input data generated by the conversion unit to one of the one or more dialog processing devices that is identified based on results of learning of the learning unit.

25. The information-processing device according to claim 15, wherein:
the learning unit is further configured to learn, on the basis of the input data and the response data, one of the one or more dialog processing devices to which the input data is input; and
the output unit is configured to output the other input data generated by the conversion unit to one of the one or more dialog processing devices that is identified based on results of learning of the learning unit.

26. The information-processing device according to claim 21, wherein the output unit is configured to select one of the one or more dialog processing devices that have been identified based on results of learning of the learning unit, based on a condition on a distance between the user terminal and a provider that provides a product to a user of the user terminal or on a delivery time, and to output the other input data generated by the conversion unit to the selected one of the one or more dialog processing devices.

27. The information-processing device according to claim 11, wherein:
the learning unit is configured to perform learning on a basis of input by a user of the user terminal or a group to which the user belongs; and
the output unit is configured to output information corresponding to a user of the user terminal or a group to which the user belongs, to the user terminal.

28. The information-processing device according to claim 12, wherein:
the learning unit is configured to perform learning on a basis of input by a user of the user terminal or a group to which the user belongs; and
the output unit is configured to output information corresponding to a user of the user terminal or a group to which the user belongs, to the user terminal.

29. The information-processing device according claim 13, wherein:
the learning unit is configured to perform learning on a basis of input by a user of the user terminal or a group to which the user belongs; and
the output unit is configured to output information corresponding to a user of the user terminal or a group to which the user belongs, to the user terminal.

30. An information-processing method comprising:
acquiring input data corresponding to spoken words input to a user terminal, and response data output from one or more dialog processing devices that perform processing according to the input data;
learning an input rule for data to be input to the one or more dialog processing devices, on the basis of the input data and the response data;
converting the input data into another input data so that the input data meets an input rule that has been learned for the one or more dialog processing devices to which the input data is to be input; and
outputting the other input data to the one or more dialog processing devices.
